(19) United States
(12) Patent Application Publication
(10) Pub. No.: US 2023/0063144 A1
(43) Pub. Date: Mar. 2, 2023

(54) SYSTEM AND METHOD FOR INSTALLATION OF HEAT RESISTANT CASTABLES

(71) Applicant: HarbisonWalker International Holdings, Inc., Moon Township, PA (US)

(72) Inventor: Stephen Karns, Spring, TX (US)

(73) Assignee: HarbisonWalker International Holdings, Inc., Moon Township, PA (US)

(21) Appl. No.: 17/897,299

(22) Filed: Aug. 29, 2022

Related U.S. Application Data
(60) Provisional application No. 63/239,479, filed on Sep. 1, 2021.

(51) Int. Cl. B01F 25/72; B01F 23/50; B01F 35/00; B01F 35/32

(52) U.S. Cl. CPC B01F 25/72; B01F 23/59; B01F 23/56; B01F 35/186; B01F 35/32045; B01F 2101/28

(57) ABSTRACT

A multi-module system for applying a refractory monolithic onto an object includes a power module and a placement module, separated and distinct from the power module. The power module includes a hydraulic pump and a prime mover drivably coupled to the hydraulic pump. The placement module includes a mixer for receiving a dry refractory material and a liquid, the mixer operative to mix the dry refractory material and liquid to produce a wet monolithic, and a pump coupled to the mixer and configured to move the wet monolithic out of the mixer. A hydraulic conduit is couplable between the hydraulic pump and at least one of the mixer or the pump, whereby the at least one of the mixer or the pump is driven by hydraulic power produced by the hydraulic pump.

### RELATED APPLICATION DATA

This application claims priority of U.S. Provisional Application No. 63/239,479 filed on Sep. 1, 2021, which is incorporated herein by reference in its entirety.

### FIELD OF THE INVENTION

The present invention relates generally to refractory monolithics and, more particularly, to a device and method for installation of refractory monolithics in small to medium sized applications.

### BACKGROUND OF THE INVENTION

Heat resistant concretes, or also called refractory monolithics, are dry blends of various ingredients combined with bonding agents which, after the addition of water, convert into wet, flowable, formable masses. These wet masses are then transferred, placed or formed into a shape or structure and, after a period of time, harden into a solid arrangement. The compositions of these dry blends are designed to deliver optimum characteristics in use at a specific elevated temperature, in a specific corrosive environment, in a specific type of hot processing unit, or for a specific type of the high temperature process. There are hundreds or even thousands of these dry concrete compositions commercially available. The selection for each specific use is not only based on the optimum performance characteristics in desired practice, but also by the availability, suitability, and fitness of the installation equipment.

Refractory monolithics have an inherent limitation for installation in that they require water or other liquids, such as, for example, colloidal silica, for wetting during mixing. After mixing and wetting these refractory monolithics require sufficient working time while they are in a formable or flowable liquid phase and require wet transportation to the location of placement, such as casting form. In addition, when a rapid set is needed for configuration of a form-free standing structure, the installation equipment must have special arrangement for pumping of the formable castable and special dispensing nozzle equipped with a measured introduction of hardening accelerants.

Conventionally, two processes are utilized to prepare and apply refractory monolithics, namely shotcreting and gunning. In shotcreting, water is added to the “dry” refractory monolithic, also called shotcrete, to form a wet mass, and this wet mass is conveyed through a hose and projected at a high velocity onto a surface. In contrast to shotcreting, gunning conveys the dry refractory monolithic, also called gunite, to a nozzle, where water is added to the dry monolithic as it is expelled from the nozzle.

Advantages of shotcreting over gunning include a dustless nozzle (since the material is completely wet, no dust is present), which reduces exposure to respirable crystalline silica dust. Also, since there is less dust, there is less to cleanup when the installation is complete. Shotcrete also allows for simultaneous operations to be conducted in proximity or confined spaces, and typically has superior properties compared to gunite, particularly having improved consistency due to measured and accurate addition of water. Further, shotcreting results in substantially less rebound (i.e., material that does not stick to surface and must be discarded), which is on the order of 1-5%.

For installation of form-free structures, shotcreting requires large, heavy, and expensive pumping equipment that can be difficult to clean and maintain, particularly in the field. Additionally, the equipment is not economical for smaller size repairs or installation projects, and can have problems with surging material at the nozzle when output rate is generally low (e.g., less than 10 cubic yards per hour). If used on scaffolding, engineered, complex, and expensive scaffolding structures are required due to the equipment weight.

The use of a dry gunning installation machine solves the inherent problems associated with the use of the shotcreting machine. In particular, the equipment is much smaller, lighter, and has lower cost. Further, the equipment is easy to clean and maintain since there is no wet monolithic within the machine itself, and it is economical for small size installation projects. Gunning, in many instances, is the installation choice for small size repairs. However, gunite mixes have disadvantages. In particular, gunning installation machines produce a substantial amount of dust at the nozzle, and the resulting structure has inferior properties relative to shotcrete. Further, gunning produces a mixture that is inconsistent due to the way water is mixed with the material at the nozzle, and also undergoes much more rebound (10-15%).

### SUMMARY OF THE INVENTION

The present invention addresses a need for refractory shotcrete installations for small to medium sized jobs by utilizing a unique piece of equipment that has a low cost, is easier to use and maintain, and has a smaller, more flexible footprint relative to conventional devices. In accordance with the invention, a multi-module system is provided in which power is generated on one module, while mixing and pumping of the mix is performed on another (different) module that can be separated from the other module by several hundred feet.

Advantages of a device and method in accordance with the invention are that smaller, lighter, and more-simple ball-valve pumps can be used for refractory monolithic pumping. Further, the pump can include separate structural elements, or modules, which can be configured for independent physical placement thereby allowing for more flexibility at the installation site. These separate modules can have specific functions. For example, a mixer/pump module can include a wet mixer and ball-valve pump in various sizes. A power module can include a prime mover and hydraulic pump in various power supplies (e.g., diesel, electric, etc.). The modules can be connected with hydraulic and/or electrical lines to provide separation between the modules of 10 to 200 feet or more.

Additionally, the mixer/pump module can be adjusted for reduced dust exposure by utilizing a mixer cover, bag skirt, and dust collector connection. The mixer/pump module is also free of any harmful emission and therefore can be used in or near enclosed and confined spaces. The mixer/pump module is configured for easy clean-out and low clean-out waste generation, which is foremost improvement over complicated and wasteful clean-out associated with swing-tube type installation machines. More specifically, use of a ball-valve pump in the mixer/pump module results in fewer moving parts relative to conventional pumps and thus the time required to tear down and clean the pump is significantly reduced. Further, use of hinged connections and fewer removable parts help simplify cleaning of the mixer/pump module. In addition, the mixer/pump module is relatively light with less requirement for area of placement, less requirement for scaffolding construction and at lower cost, and is suitable for an easy transport by forklifts or elevators. Further, any mixer/pump module option (i.e., 500-lb mixer, 1000-lb mixer, etc.) is operable and interchangeable with any power module option (e.g., diesel engine, electric motor, etc.).

According to one aspect of the invention, a multi-module casting system for applying a refractory monolithic onto a structure includes: a power module having a hydraulic pump, and a prime mover drivably coupled to the hydraulic pump. A placement module, separate and distinct from the power module, includes a mixer for receiving a dry refractory material and a liquid, the mixer operative to mix the dry refractory material and liquid to produce a wet monolithic. A pump is coupled to the mixer and configured to move the wet monolithic out of the mixer. A hydraulic conduit is couplable between the hydraulic pump and at least one of the mixer or the pump, whereby the at least one of the mixer or the pump is driven by hydraulic power produced by the hydraulic pump.

In one embodiment, the pump includes a ball-valve pump.

In one embodiment, the prime mover includes one of an internal combustion engine or an electric motor.

In one embodiment, the internal combustion engine includes one of a diesel engine or a gasoline engine.

In one embodiment, the power module includes a first controller communicatively coupled to at least one of the mixer or the pump, the first controller configured to monitor and control operation of the at least one of the mixer or the pump.

In one embodiment, the system includes a user interface communicatively coupled to the controller.

In one embodiment, the placement module includes a second controller communicatively coupled to at least one of the prime mover or the hydraulic power generator, the second controller configured to monitor and control operation of the at least one of the prime mover or the hydraulic power generator.

In one embodiment, the system includes a dust skirt arranged on the mixer, the dust skirt configured to reduce dust emissions from the mixer during introduction of dry refractory material into the mixer.

In one embodiment, the system includes a dust collection module having a vacuum, and a conduit fluidically couplable between the vacuum and the mixer.

In one embodiment, the system includes a nozzle fluidically couplable to the pump, the nozzle configured to emit pressurized wet monolithic provided by the pump.

In one embodiment, the system includes an air compressor fluidically coupled to the nozzle, wherein compressed air from the air compressor is selectively appliable to the nozzle.

In one embodiment, the system includes an activator module fluidically couplable to at least one of the pump or the nozzle, the activator module configured to apply an agent to the wet monolithic to alter a characteristic of the wet monolithic.

In one embodiment, the system includes a water tank fluidically coupled to the mixer.

According to another aspect of the invention, a method for applying a refractory monolithic onto a surface includes: generating hydraulic power on a first portable module; transmitting the generated power to a second portable module, the second portable module remote from the first portable module; mixing, on the second portable module, dry refractory material with a liquid to produce a wet monolithic; and pumping, on the second portable module, the wet monolithic for placement or expulsion from the second module into the space or onto the surface, wherein mixing and pumping utilizes the transmitted power generated by the first portable module.

In one embodiment, the second portable module is between 10 feet and 200 feet apart from the first module.

In one embodiment, pumping includes using a ball-valve pump to place or expel the wet monolithic.

In one embodiment, generating hydraulic power on a first module comprises using a prime mover to drive a hydraulic pump, wherein the prime mover and hydraulic pump are arranged on the first module.

In one embodiment, transmitting includes using a hydraulic conduit coupled between the hydraulic pump and the second module to transmit the power.

In one embodiment, the method includes collecting refractory dust emitted from the mixer and recycling the collected dust.

In one embodiment, the method includes applying an agent to the wet monolithic as the wet monolithic is expelled from the second module, wherein the agent alters a characteristic of the wet monolithic.

In one embodiment, the agent comprises an accelerator operative to reduce a set time of the wet monolithic.

Examples of the specific embodiments are illustrated in the accompanying drawings. While the invention will be described in conjunction with these specific embodiments, it will be understood that it is not intended to limit the invention to such specific embodiments. On the contrary, it is intended to cover alternatives, modifications, and equivalents as may be included within the spirit and scope of the invention. In the following description, numerous specific details are set forth in order to provide a thorough understanding of the present invention. The present invention may be practiced without some or all of these specific details. In other instances, well-known process operations have not been described in details so as to not unnecessarily obscure the present invention.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a schematic drawing of an exemplary multi-module casting system for applying a refractory monolithic in accordance with the present invention.

FIG. 2 illustrates an exemplary application of the multi-module casting system of FIG. 1, where the power module is separated from but near a placement module in accordance with the invention.

FIGS. 3A and 3B illustrate an exemplary application of the multi-module casting system of FIG. 1, where the power module is placed in an outdoor environment and the placement module is placed in an indoor environment.

FIG. 4 illustrates a placement module in accordance with the invention with a dust shield over a mixer input of the placement module.

FIGS. 5A and 5B are tables comparing the multi-modular system in accordance with the invention to conventional gunning and swing-tube systems.

FIG. 6 is a table showing performance of the multi-module system in accordance with the invention for various monolithics.

### DETAILED DESCRIPTION OF PREFERRED EMBODIMENT

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

The word “about” when immediately preceding a numerical value means a range of plus or minus 10% of that value, e.g., “about 50” means 45 to 55, “about 25,000” means 22,500 to 27,500, etc., unless the context of the disclosure indicates otherwise, or is inconsistent with such an interpretation. For example, in a list of numerical values such as “about 49, about 50, about 55, “about 50” means a range extending to less than half the interval(s) between the preceding and subsequent values, e.g., more than 49.5 to less than 52.5. Furthermore, the phrases “less than about” a value or “greater than about” a value should be understood in view of the definition of the term “about” provided herein.

As used herein, the term “refractory monolithic” refers to inorganic nonmetal materials utilized in various high-temperature equipment, e.g., for steel production, other metal-making, non-metal making, chemical-making, gas-making, heat-making, or for high-temperature reactions, and the like. Refractory monolithics are characterized by a high melting point, and are resistant to decomposition by heat, pressure, or chemical attack, and retain strength and form at high temperatures. A refractory monolithic is without definite form.

A shotcreting device and method in accordance with the invention address problems associated with swing-tube machines. In particular, the device and method in accordance with the invention enable placement of a shotcrete to be more effective for smaller installations (i.e., where use of gunite has been preferred).

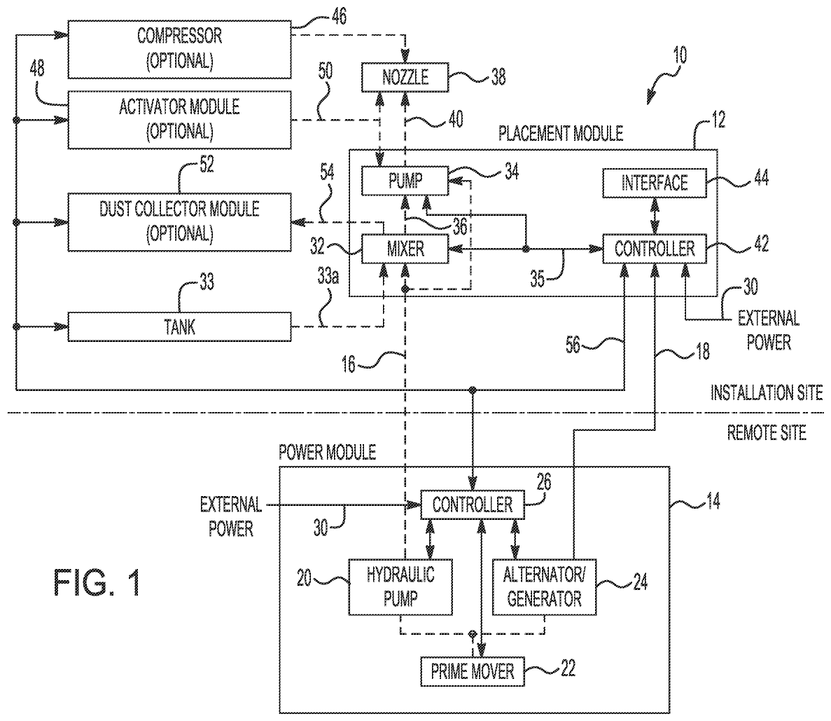

Referring initially to FIG. 1, illustrated is a schematic diagram of an exemplary multi-module casting system 10 for applying a refractory monolithic onto an object in accordance with the invention. The multi-module casting system 10 includes a first module 12, also referred to as placement module 12, and a second module 14, also referred to as power module 14. As will be discussed in more detail below, the placement module 12 and the power module 14 may be placed in different locations such that they are separated from each other (i.e., the placement module 12 and the power module 14 are separate and distinct from each other). For example, the power module 14 may be located in a different room, a different environment, etc. from that of the placement module 12. A hydraulic conduit 16, such as a flexible hydraulic conduit, couples the power module 14 to the placement module 12 to provide hydraulic power thereto. Similarly, multiple electrical, optical or other like conductors 18 may connect the power module 14 to the placement module 12 so as to communicate data therebetween and/or to provide electric power.

The power module 14 includes a hydraulic pump 20 and a prime mover 22 drivably coupled to the hydraulic pump 20. The prime mover 22, for example, may be an internal combustion engine (e.g., a diesel engine or a gasoline engine) or an electric motor. As the prime mover 22 drives the hydraulic pump 20, hydraulic power is generated that, as explained in further detail below, is provided to the placement module 14.

Optionally, the power module 14 may also include an electric power generation means, such as an alternator and/or generator 24. Alternating current and/or direct current generated by the electric power generation means 24 can be used to power components on the power module 14, such as one or more controllers 26, and/or to provide power to other devices, such as the placement module 12. Alternatively or additionally, an external power source 30 may provide electric power to the power module 14 and/or the placement module 12.

The one or more controllers 26 are operatively coupled to the hydraulic pump 20, the prime mover 22, and/or the electric power generation means 24. The controller 26 can monitor and/or control operation of these devices, as well as log data and perform other supervisory control functions.

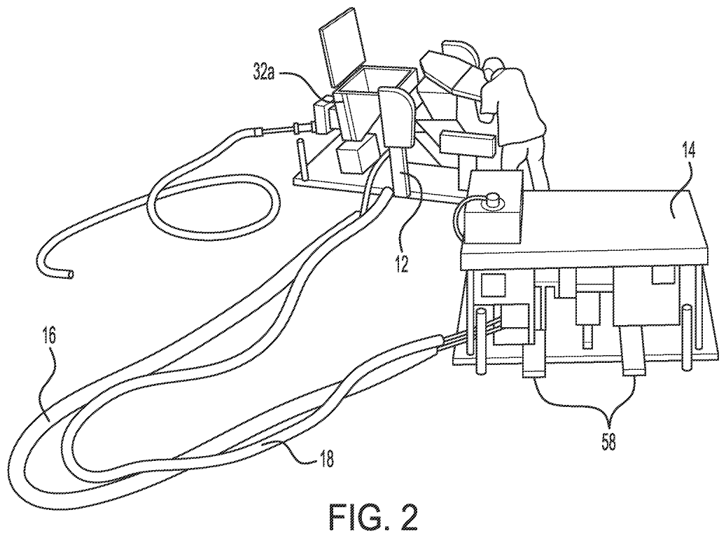

The placement module 12 includes a mixer 32 for receiving a dry refractory monolithic and a liquid. The mixer 32 is operative to mix dry refractory monolithic and liquid (e.g., water) to produce a wet monolithic. The liquid may be stored in tank 33, which is separate from the placement module 12, whereby liquid from the tank 33 can be provided to the mixer 32 via conduit 33a. The mixer 32 may include a hopper 32a (FIG. 2) or other storage means to store the wet monolithic after it has been mixed by the mixer. A pump 34, such as a ball-valve pump, is fluidically coupled to the mixer 32 via conduit 36 and to a nozzle 38 via conduit 40, the pump configured to move the wet monolithic out of the mixer 32 and nozzle 38, the nozzle configured to emit pressurized wet monolithic, which is provided by the pump, as a spray. Both the mixer 32 and the pump 34 receive hydraulic power from the hydraulic pump 30 located on the power module 14, where the hydraulic power is transmitted via conduit 16.

A ball-valve pump is a pump that is actuated entirely by flow of the wet monolithic. A ball-valve pump operates using a set of hydraulic powered pistons with two sets of balls. The first set of balls is located directly below the hopper (the intake side) and the second set of balls is located immediately before the discharge (the discharge side) to conduit the wet monolithic to the installation location. As one set, consisting of a cylinder, an intake ball, and a discharge ball, operates on the intake cycle the other set operates on the discharge cycle. When conducting intake, the cylinder pulls back and draws in material from the hopper with the intake ball allowing wet monolithic to flow around it, while at the discharge side the discharge ball has sealed on a seat, preventing material that has already been discharged from flowing back into the cylinder. When conducting discharge, the cylinder pushes wet monolithic toward the discharge which opens the discharge ball, and the intake ball is forced upward where it seats and prevents material from flowing into the hopper.

In the illustrated embodiment of FIG. 1, the placement module 12 also includes a controller 42, the controller 42 being communicatively coupled to the pump 32 and/or mixer 34 via conductors 35 to monitor and/or control operation of the respective devices. The controller 42 also may be communicatively coupled to the controller 26 of the power module 14 in order to exchange control and/or monitored data between the two controllers. A user interface 44, such as pushbuttons, touch screen, or the like, is operatively coupled to the controller 42 to enable a user to control the system 10. The controller 42 and user interface 44 may receive electrical power from the electric power generation means 24 of the power module 14 via conductors 18, or may receive power from external power source 30.

While a controller is shown in each of the placement module 12 and the power module 14, a single controller may be utilized to control devices on both the placement module 12 and the power module 14. Such single controller could be located on the placement module 12, the power module 14, or remote from both modules.

Due to the modular nature of the system 10, the power module 14 and the placement module 12 are separate and distinct from one another. This enables placement of the power module 14, which may generate noxious fumes and/or noise, in a location that is away from the placement module 12. This reduces the risk of exposing workers to the hazards associated with noxious fumes and/or excessive noise.

The system 10 can optionally include an air compressor 46 fluidically coupled to the nozzle 38. Compressed air from the air compressor 46 can propel the wet monolithic from the nozzle 38, and onto the target structure or surface, e.g., deposition on a precast shape, refractory lining, refractory free structure, refractory anchored structure, or any refractory lining or part.

Optionally, the system 10 may further include an activator module 48 fluidically coupled to the nozzle 38 and/or pump 34 via conduit 50. The activator module 48 is configured to apply an agent to the wet monolithic to alter a characteristic of the wet monolithic just prior to application to the castable object. For example, the agent can be a hardening or quick drying agent that, when applied to the wet monolithic, reduces the set time for the wet monolithic.

The system 10 may also optionally include a dust collector module 52. The dust collector module can include one or more of a vacuum, filtering means, and a conduit 54 fluidically coupled between the dust collector module 52 and the mixer 32. The dust collector module 52 can catch dust generated as the mixer 32 is loaded with the dry refractory monolithic, thereby reducing cleanup time after the repair/construction is complete.

Further, one or more of the compressor 46, activator module 48, dust collector module 52 and tank 33 may be communicatively coupled to the controller 42 via conductors 56. In this manner, the controller 42 can monitor and control each of the respective modules.

With additional reference to FIG. 2, illustrated is an exemplary implementation of a multi-module casting system 10 in accordance with the invention. As illustrated, a power module 14 is separated from a placement module 12, where hydraulic conduit 16 provides hydraulic power from the power module 12 to the placement module 12 (and in particular to the pump 34 and mixer 32 of the placement module 12). Additionally, in the illustrated embodiment electric power is also provided from the power module 14 to the placement module 12 via conductors 18. The implementation illustrated in of FIG. 2 may be applicable to situations where the installation occurs outdoors and there is little concern for fumes or noise caused by the power module 14. Because the placement module 12 is relatively light, it can be easily moved around as needed without the need to move the power module 14. The exemplary placement module 12 preferably has a footprint of less than 36 square feet and weighs less than 5000 pounds. To facilitate movement of the placement module 12 and the power module 14, each may be formed on a sub-frame having receptacles 58 arranged along a bottom section of the respective structures, the receptacles configured to accept a fork lift or like device. Such configuration effectively provides an integrated “skid” that allows for easy and flexible transport of the system 10 to, from and within the locality of the installation job.

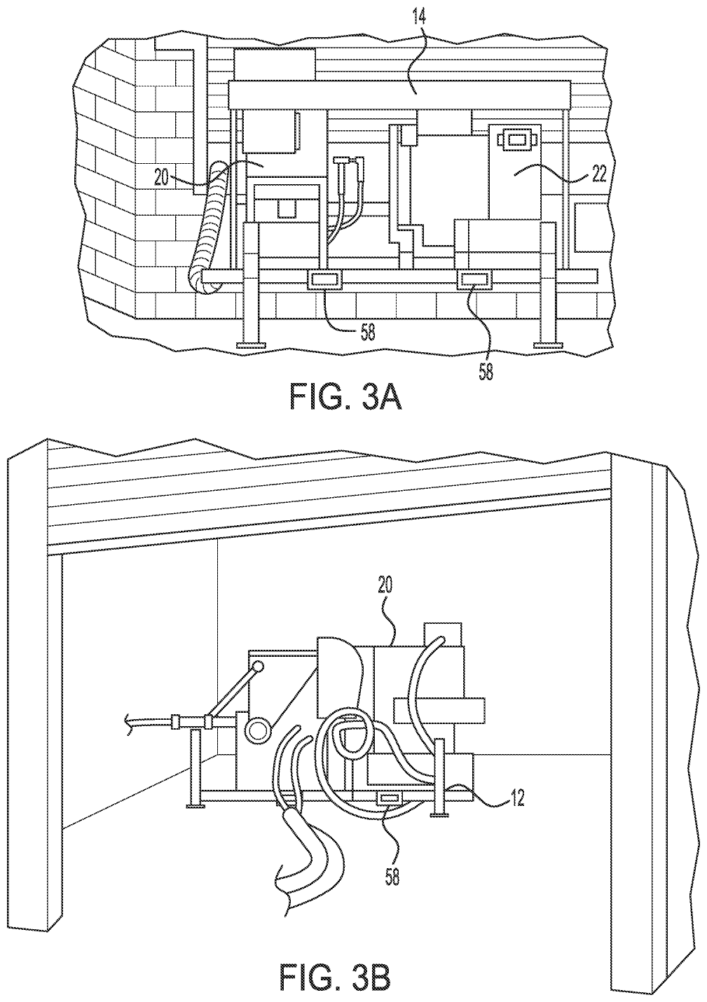

FIGS. 3A and 3B illustrate another implementation of the multi-module casting system 10 in accordance with the invention. In FIGS. 3A and 3B, the power module 14 is located in a completely different location than the placement module 12. Specifically, and as seen in FIG. 3A, the power module 14 is located outdoors away from the installation site, while as seen in FIG. 3B the placement module 12 is located indoors at the installation site. Hydraulic and electric power are transmitted from the power module 14 to the placement module 12 via the hydraulic conduit 14 and conductors 18, which in the illustrated example pass through a retractable door of a building. The implementation illustrated in FIGS. 3A and 3B is advantageous in that the workers are not exposed to the noise and fumes that may be generated by the power module 14, thereby providing a safer work environment relative to conventional shotcreting systems.

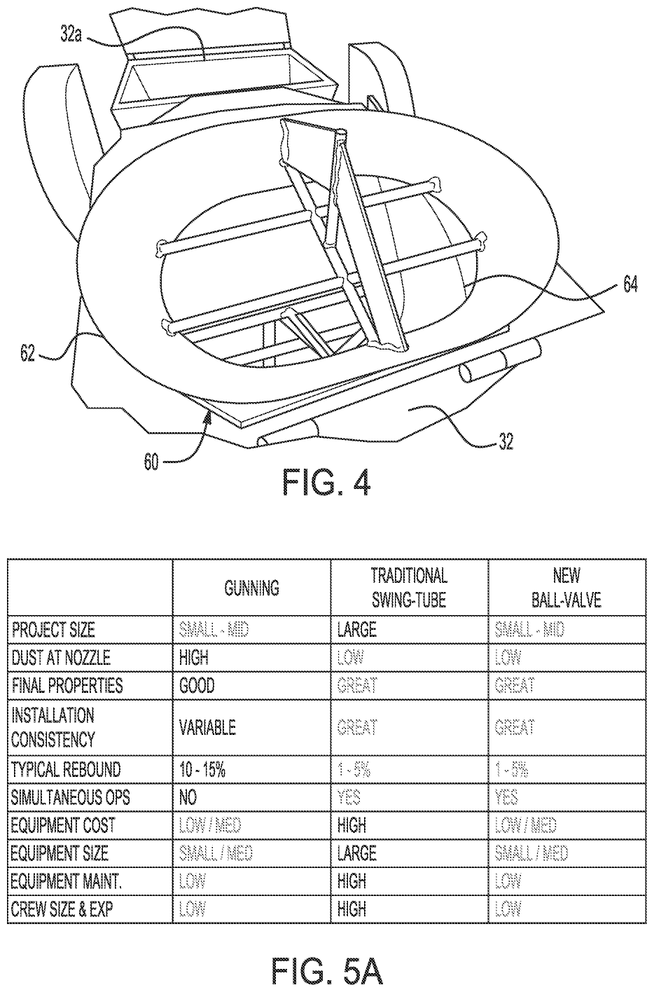

Moving now to FIG. 4, illustrated is a dust skirt 60 for reducing dust during mixer loading. The dust skirt 60 may be in addition to or as an alternative to the dust collection module 52. The exemplary dust skirt 60 of FIG. 4 is arranged on an inlet of mixer 32, and has a semi-funnel shape in which an inlet 62 is larger than and above an outlet 64 of the dust skirt 60 (the inlet 62 is larger and higher in elevation than the outlet 64). As dry refractory monolithic is poured into the dust skirt 60, the dry refractory monolithic is guided downward and toward a center region of the mixer 32 where it is then deposited into the mixer 32. Dust may be generated as the dry refractory monolithic enters the mixer 32, and this dust tends to be pushed outward toward the walls of the mixer 32 by the incoming dry refractory monolithic. The dust strikes the outer walls of the mixer 32 and is directed upward toward a top region of the mixer 32. Due to the downward/tapering shape of the dust skirt 60, the rising dust becomes trapped under the dust skirt 60 and is prevented from escaping the mixer 32. Thus, the dust skirt 60 can reduce the propagation of airborne dust during the filling of the mixing chamber when fed with the dry castable blend.

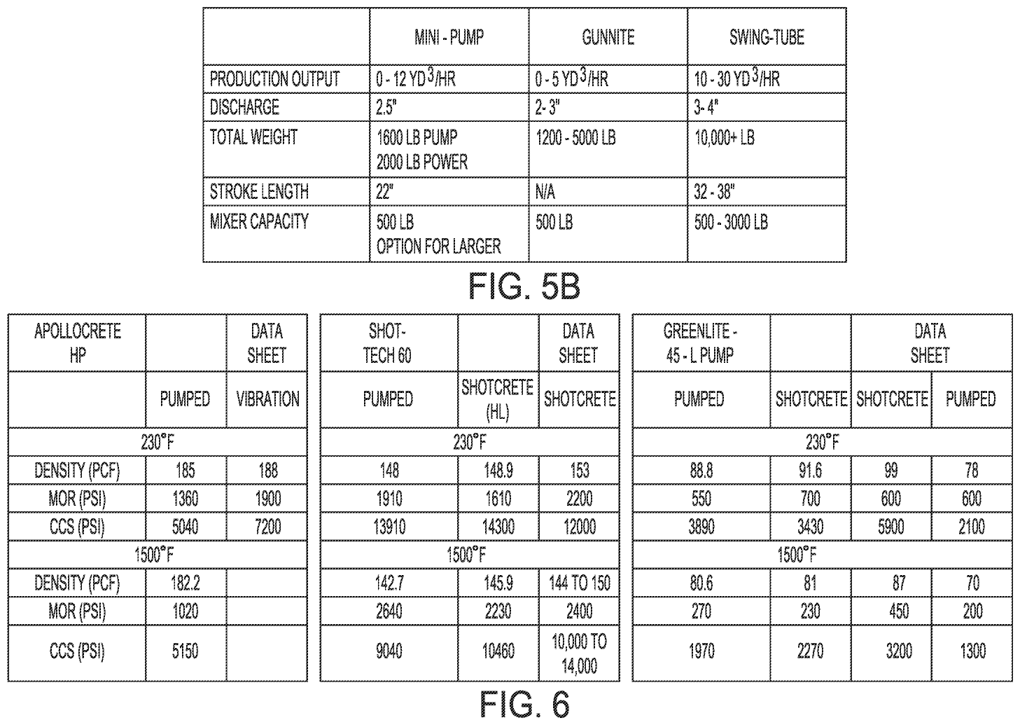

Referring briefly to FIGS. 5A and 5B, FIG. 5A demonstrates that the multi-module system 10 utilizing a mini ball-valve pump solves the deficiencies associated with either the gunning or traditional swing-tube systems. The multi-module system 10 combines the small to midsize equipment size, low cost, low maintenance and low crew size associated with the gunning equipment with great final properties, great installation consistency, low rebound and simultaneous placement options associated with the traditional swing-tube system. FIG. 5B illustrates the output flexibility, size, and capacities of a mini-pump ball-valve system 10 compared against the other two conventional methods. The output from the multi-module system 10 according to the invention is two times faster than the gunning method, while having the advantage of a lower-weight placement module 12. The smaller size of the mini-pump installation system 10 is a significant advantage in situations where a project is implemented in limited space or in small, enclosed processing units.

The versatility and flexibility of the multi-modular system in accordance with the invention is demonstrated by achieving acceptable installed product properties compared to typical values achieved by standard installation methods. The table in FIG. 6 illustrates examples of such test results. For example, APOLLOCRETE™ HP shotcrete is high density castable product suitable for applications where large load and high temperatures are expected; SHOT_TECH 60® shotcrete mix is medium density refractory castable suited for high temperatures and high thermal shock environment; GREENLITE™-45-L PUMP pumping mix is low density refractory castable for high temperature environment where in addition to low weight also high structural strength is required.

A method of using the system 10 in accordance with the invention to apply a refractory castable onto a surface will now be described. Initially, the placement module 12 is located in the region of the castable object, while the power module 14 is located away from the placement module 12 (preferable in another room or outdoor location, which may be 10 to 200 feet or more away from the placement module 12). The power module 14 is commanded to generate power (e.g., hydraulic power) by activating the prime mover 22, which is coupled to the hydraulic pump 20 (each being located on the power module 14). The generated power is transmitted to the placement module 12 via a hydraulic conduit where it is utilized by the mixer 32 and pump 34.

Dry refractory monolithic is added to the mixer 32 along with water from tank 33. Dust that may be generated as the dry refractory material is added to the mixer 32 can be collected and/or recycled via dust collector module 52 and/or retained within the mixer 32 via dust skirt 60. Using power generated by the power module 14, the mixer proceeds to mix the dry refractory material and water to produce a wet monolithic that is retained within a hopper 32a of the pump 34.

The pump 34, which is integral to the mixer 32 and also receives power from the power module 14, operates to pressurize the wet monolithic and transport, via conduit 40, the pressurized wet monolithic to the nozzle 38, where it is expelled and deposited onto the object. To enhance or alter properties of the wet monolithic, e.g., to shorten the hardening time, the activator module 48 can apply an agent to the wet monolithic as it is expelled from the nozzle 38.

Accordingly, the device and method in accordance with the invention provide a shotcrete device that can be utilized in small installation applications. In particular, by placing the power generation away from the mixing and spraying operations, workers are not subjected to the noise and fumes associated with power generation. Further, the use of a ball-valve pump enables better flow control of the wet monolithic (particularly in smaller applications), which can enhance the quality of the casted material and/or provide improved control for smaller castable objects.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

What is claimed is:

1. A multi-module casting system for applying a refractory castable onto a structure, comprising:
a power module including
a hydraulic pump, and
a prime mover drivably coupled to the hydraulic pump;
a placement module separate and distinct from the power module, the placement module including
a mixer for receiving a dry refractory material and a liquid, the mixer operative to mix the dry refractory material and liquid to produce a wet monolithic, and
a pump coupled to the mixer and configured to move the wet monolithic out of the mixer; and
a hydraulic conduit couplable between the hydraulic pump and at least one of the mixer or the pump, whereby the at least one of the mixer or the pump is driven by hydraulic power produced by the hydraulic pump.

2. The system according to claim 1, wherein the pump comprises a ball pump.

3. The system according to claim 1, wherein the prime mover comprises one of an internal combustion engine or an electric motor.

4. The system according to claim 3, wherein the internal combustion engine comprises one of a diesel engine or a gasoline engine.

5. The system according to claim 1, wherein the power module comprises a first controller communicatively coupled to at least one of the mixer or the pump, the first controller configured to monitor and control operation of the at least one of the mixer or the pump

6. The system according to claim 5, further comprising a user interface communicatively coupled to the controller.

7. The system according to claim 1, wherein the placement module comprises a second controller communicatively coupled to at least one of the prime mover or the hydraulic power generator, the second controller configured to monitor and control operation of the at least one of the prime mover or the hydraulic power generator.

8. The system according to claim 1, further comprising a dust skirt arranged on the mixer, the dust skirt configured to reduce dust emissions from the mixer during introduction of dry refractory material into the mixer.

9. The system according to claim 1, further comprising a dust collection module including a vacuum, and a conduit fluidically couplable between the vacuum and the mixer.

10. The system according to claim 1, further comprising a nozzle fluidically couplable to the pump, the nozzle configured to emit pressurized wet monolithic provided by the pump.

11. The system according to claim 10, further comprising an air compressor fluidically coupled to the nozzle, wherein compressed air from the air compressor is selectively appliable to the nozzle.

12. The system according to claim 1, further comprising an activator module fluidically couplable to at least one of the pump or the nozzle, the activator module configured to apply an agent to the wet monolithic to alter a characteristic of the wet monolithic.

13. The system according to claim 1, further comprising a water tank fluidically coupled to the mixer.

14. A method for applying a refractory monolithic onto a surface, comprising:
generating hydraulic power on a first portable module;
transmitting the generated power to a second portable module, the second portable module remote from the first portable module;
mixing, on the second portable module, dry refractory material with a liquid to produce a wet monolithic; and
pumping, on the second portable module, the wet monolithic for placement or expulsion from the second module into the space or onto the surface,
wherein mixing and pumping utilizes the transmitted power generated by the first portable module.

15. The method according to claim 14, wherein the second portable module is between 10 feet and 200 feet apart from the first module.

16. The method according claim 14, wherein pumping includes using a ball-valve pump to place or expel the wet monolithic.

17. The method according to claim 14, wherein generating hydraulic power on a first module comprises using a prime mover to drive a hydraulic pump, wherein the prime mover and hydraulic pump are arranged on the first module.

18. The method according to claim 17, wherein transmitting includes using a hydraulic conduit coupled between the hydraulic pump and the second module to transmit the hydraulic power.

19. The method according to claim 14, further comprising collecting refractory dust emitted from the mixer and recycling the collected dust.

20. The method according to claim 14, further comprising applying an agent to the wet monolithic as the wet monolithic is expelled from the second module, wherein the agent alters a characteristic of the wet monolithic.

21. The method according to claim 20, wherein the agent comprises an accelerator operative to reduce a set time of the wet monolithic.
